(19) United States
(12) Patent Application Publication
(10) Pub. No.: US 2015/0049491 A1
(43) Pub. Date: Feb. 19, 2015

(54) METHOD OF MAKING COMPONENTS INCLUDING QUANTUM DOTS, METHODS, AND PRODUCTS

(71) Applicant: QD VISION, INC., Lexington, MA (US)

(72) Inventors: Karthik VENKATARAMAN, Arlington, MA (US); John R. LINTON, Concord, MA (US); Robert J. NICK, Pepperell, MA (US); Abhishek GUPTA, Cambridge, MA (US)

(21) Appl. No.: 14/460,107

(22) Filed: Aug. 14, 2014

Related U.S. Application Data
(63) Continuation of application No. PCT/US2013/025233, filed on Feb. 7, 2013.
(60) Provisional application No. 61/599,234, filed on Feb. 15, 2012.

(51) Int. Cl. F21K 99/00; B29C 45/14; B29C 45/16; F21V 9/16

(52) U.S. Cl. CPC F21K 9/56; F21V 9/16; B29C 45/14; B29C 45/1671; Y10S 977/774; Y10S 977/95; B82Y 20/00
USPC 362/318; 264/21; 264/1.7; 977/774; 977/950

(57) ABSTRACT

A glass tube including quantum dots under oxygen-free conditions is described. An optical component and other products including such glass tube, a composition including quantum dots, and methods are also disclosed.

This application is a continuation of International Application No. PCT/US2013/025233, filed 7 Feb. 2013, which was published in the English language as International Publication No. WO 2013/122819 on 22 Aug. 2013, which International Application claims priority to U.S. Provisional Patent Application No. 61/599,234, filed on 15 Feb. 2012. Each of the foregoing is hereby incorporated herein by reference in its entirety for all purposes.

### TECHNICAL FIELD OF THE INVENTION

The present invention relates to the technical field of quantum dots and methods, compositions and products including quantum dots.

### BRIEF SUMMARY OF THE INVENTION

Embodiments of the present invention are directed to an optical material including quantum dots contained within a vessel having an oxygen-free environment therein to generate light. According to one aspect, a method of making a quantum dot-containing vessel is provided including the steps of introducing a quantum dot formulation into the vessel under oxygen-free conditions and sealing the vessel wherein the quantum dot formulation within the vessel is under oxygen-free conditions, such as an oxygen-free environment within the vessel. According to one aspect, the vessel includes a sealed end before introduction of the quantum dot formulation. According to one aspect, the vessel is evacuated under vacuum before introduction of the quantum dot formulation. According to one aspect, the quantum dot formulation is introduced into the vessel by capillary action. Methods of introducing fluids into a vessel by capillary action are known to those of skill in the art. According to one aspect, the quantum dot formulation is introduced into the vessel by pressure. Methods of introducing fluids into a vessel by pressure are known to those of skill in the art. According to one aspect, the quantum dot formulation is introduced into the vessel by gravity. Methods of introducing fluids into a vessel by gravity are known to those of skill in the art. According to one aspect, the quantum dot formulation is under nitrogen when introduced into the vessel. According to one aspect, the vessel is sealed under oxygen-free conditions after introduction of the quantum dot formulation. According to one aspect, the vessel can be a container or tube. According to one aspect, the vessel is a capillary.

According to one aspect, the quantum dot formulation may be a combination of certain quantum dots, such as quantum dots that emit green light wavelengths and quantum dots that emit red light wavelengths, that are stimulated by an LED emitting blue light wavelengths resulting in the generation of trichromatic white light. According to one aspect, the quantum dots are contained within an optical component such as a tube under oxygen-free conditions which receives light from an LED. Light generated by the quantum dots is delivered via a light guide for use with display units. According to certain aspects, light generated by quantum dots, such as trichromatic white light, is used in combination with a liquid crystal display (LCD) unit or other optical display unit, such as a display back light unit. One implementation of the present invention is a combination of the quantum dots within a tube under oxygen-free conditions, an LED blue light source and a light guide for use as a backlight unit which can be further used, for example, with an LCD unit.

Optical components that include quantum dots according to the present invention include tubes of various configurations, such as length, width, wall thickness, and cross-sectional configuration. The term “tube” as used in the present disclosure includes a capillary, and the term “tube” and “capillary” are used interchangeably. Tubes of the present invention are generally considered light transmissive such that light can pass through the wall of the tube and contact the quantum dots contained therein thereby causing the quantum dots to emit light. According to certain aspects, tubes may be configured to avoid, resist or inhibit cracking due to stresses placed on the tube from polymerizing a matrix therein or heating the tube with the polymerized matrix therein. In this aspect, the tubes of the present invention are glass tubes for use with quantum dots. Such tubes can have configurations known to those of skill in the art. Such tubes may have a stress-resistant configuration and exhibit advantageous stress-resistant properties. The tube containing the quantum dots is also referred to herein as an optical component. An optical component can be included as part of a display device.

According to one aspect, the tube of the present disclose is made from a transparent material and has a hollow interior. Quantum dots reside within the tube and may be contained within a polymerized matrix material which is light transmissive. A polymerizable composition including quantum dots and at least monomers can be introduced into the tube under oxygen free conditions. The tube may be sealed to maintain the oxygen-free nature of the polymerizable composition. The polymerizable composition is then polymerized within the tube using light or heat, for example. According to certain aspects, the tube has sufficient tolerance or ductility to avoid, resist or inhibit cracking during the curing of the monomers into a polymerized matrix material within the tube. The tube also has sufficient tolerance or ductility to avoid, resist or inhibit cracking during thermal treatment of the tube with the polymerized quantum dot matrix therein. According to certain aspects, the components for making a polymerized quantum dot matrix include polymerizable materials exhibiting ductility when polymerized. According to certain aspects, the components for making a polymerized quantum dot matrix include materials which resist yellowing, browning or discoloration when subject to light. According to one aspect, the combination of the tube of the present invention and the ductile polymerized matrix result in a stress resistant or crack resistant optic. According to an additional aspect, the polymerized matrix under oxygen-free conditions within the tube provides advantageous light emitting properties.

Embodiments of the present invention are directed to the mixtures or combinations or ratios of quantum dots that are used to achieve certain desired radiation output. Such quantum dots can emit red and green light of certain wavelength when exposed to a suitable stimulus. Still further embodiments are directed to various formulations including quantum dots which are used in various light emitting applications. Formulations including quantum dots may also be referred to herein as “quantum dot formulations” or “optical materials”. For example, quantum dot formulations can take the form of flowable, polymerizable fluids, commonly known as quantum dot inks, that are introduced into the tube and then polymerized to form a quantum dot matrix. According to certain aspects, quantum dot formulations can take the form of flowable, polymerizable fluids, commonly known as quantum dot inks, that are introduced into the tube under oxygen-free conditions and then polymerized to form a quantum dot matrix. The tube is then used in combination with a light guide, for example.

Such formulations include quantum dots and a polymerizable composition such as a monomer or an oligomer or a polymer capable of further polymerizing. Additional components include at least one or more of a crosslinking agent, a scattering agent, a rheology modifier, a filler, a photoinitiator or thermal initiator and other components useful in producing a polymerizable matrix containing quantum dots. Polymerizable compositions of the present invention include those that avoid yellowing when in the form of a polymerized matrix containing quantum dots. Yellowing leads to a lowering of optical performance by absorbing light emitted by the quantum dots and light emitted by the LED which can lead to a shift in the color point.

Embodiments of the present invention are still further directed to various backlight unit designs including the quantum dot-containing tubes, LEDs, and light guides for the efficient transfer of the generated light to and through the light guide for use in liquid crystal displays. According to certain aspects, methods and devices are provided for the illumination and stimulation of quantum dots within tubes and the efficient coupling or directing of resultant radiation to and through a light guide.

Additional aspects include methods for introducing a quantum dot formulation into a vessel or tube under oxygen-free conditions and then sealing the vessel or tube, such as under oxygen free conditions, such that the quantum dot formulation within the sealed tube is under an oxygen-free environment. Certain aspects include providing a tube design, having one or both ends sealed, which withstands stresses relating to polymerization of a polymerizable quantum dot formulation therein or stresses relating to heating the tube containing the polymerized quantum dot matrix therein. Such tube design advantageously avoids, resists or inhibits cracking from such stresses which can allow oxygen into the tube. Oxygen may degrade quantum dots during periods of high light flux exposure. Accordingly, an optical component including a glass tube having a quantum dot matrix therein under oxygen-free conditions can improve the performance of a polymerized quantum dot-containing matrix disposed therein. Still accordingly, an optical component including a glass tube having advantageous or improved stress-resistant properties can improve the performance of a polymerized quantum dot-containing matrix disposed therein.

Embodiments are further provided for a backlight unit including quantum dots within a stress-resistant tube such as a glass tube described herein under oxygen-free conditions and having each end sealed and positioned within the backlight unit, and component to, an LED. Preferably, a polymer matrix that avoids, resists or inhibits yellowing is utilized. Such a polymerized quantum dot matrix may have a component that increases ductility of the matrix which avoids, resists or inhibits cracking of the matrix due to shrinkage. One exemplary material is lauryl methacrylate. Such an LED of the present invention utilizes quantum dots to increase color gamut and generate higher perceived brightness.

Embodiments are further provided for a display including an optical component taught herein.

Embodiments are still further provided for a device (e.g., but not limited to, a light-emitting device) including an optical component taught herein.

Each of the claims set forth at the end of the present application are hereby incorporated into this Summary section by reference in its entirety.

The foregoing, and other aspects and embodiments described herein all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed. Other embodiments will be apparent to those skilled in the art from consideration of the specification and practice of the invention disclosed herein.

### BRIEF DESCRIPTION OF THE DRAWINGS

In the drawings:

FIGS. 1A, 1B and IC are drawings of a tube of the present invention. FIG. 1A is a front view of a tube of the present invention. FIG. 1B is a top view of a tube of the present invention. FIG. 1C is a top front perspective view of a tube of the present invention.

FIG. 1D is a schematic of a system for filling one or more tubes or capillaries.

FIG. 1E is a schematic of a system for filling one or more tubes or capillaries.

FIG. 2 is a flow chart describing a capillary fill procedure.

FIG. 3 depicts a cross-section of a drawing of an example of an embodiment of a tube in accordance with the present invention.

FIG. 4 is a schematic of a system for maintaining and/or processing a quantum dot formulation.

FIG. 5 is a schematic of a system for maintaining and/or processing a quantum dot formulation.

FIG. 6 is a schematic of a system for maintaining and/or processing a quantum dot formulation.

FIG. 7 is a schematic of a system for maintaining and/or processing a quantum dot formulation.

The attached figures are simplified representations presented for purposes of illustration only; the actual structures may differ in numerous respects, including, e.g., relative scale, etc.

For a better understanding to the present invention, together with other advantages and capabilities thereof, reference is made to the following disclosure and appended claims in connection with the above-described drawings.

### DETAILED DESCRIPTION OF THE INVENTION

Embodiments of the present invention are directed to the use of a vessel or tube such as a glass tube that includes semiconductor nanocrystals, known as quantum dots, under oxygen-free conditions, such as an oxygen-free environment within the vessel or tube. The quantum dot-containing vessel can be in combination with a stimulating light to produce light of one or more wavelengths including, e.g., trichromatic white light which can be used in various lighting applications such as back light units for liquid crystal displays. The glass tube is preferably light transmissive. The glass tube described herein in combination with the quantum dots is also referred to herein as an optical component.

According to certain aspects of the present invention, a vessel in the shape of a tube is provided which includes quantum dots under oxygen-free conditions. The tube is hollow and can be fashioned from various light transmissive materials including glass.

According to one aspect, the tube has a stress-resistant or stress-tolerant configuration and exhibits stress-resistant or stress-tolerant properties when subjected to stresses from polymerizing a formulation therein or heating the tube with the polymerized formulation therein. According to this aspect, a glass tube with such stress-resistant or stress tolerant properties avoids, resists or inhibits cracking due to stresses during manufacture of an optical component including the glass tube, manufacture and/or use in a display device, and during cycling of the display device. According to an additional aspect, a glass tube with such stress-resistant or stress tolerant properties having a polymer matrix therein that includes a material that provides ductility avoids, resists or inhibits cracking due to stresses during manufacture of an optical component including the glass tube, manufacture and/or use in a display device, and during cycling of the display device. The tube has dimensions suitable for application within a display device. The glass tube may include borosilicates. The glass tube may include soda lime. The glass tube may include borosilicates and soda lime. According to one aspect, borosilicates are preferred materials for glass tubes of the present invention.

A tube within the scope of the present invention has a length of between about 50 mm and about 1500 mm, between about 500 mm and about 1500 mm or between about 50 mm and 1200 mm and usually has a length comparable to a light guide within a display device. A tube within the scope of the present invention has a wall thickness sufficient to withstand stresses due the polymerization of the quantum dot matrix and heating of the tube and matrix combination. Suitable wall thicknesses include a thickness between about 250 microns and about 700 microns, about 275 microns and about 650 microns, about 300 microns and about 500 microns, about 325 microns and about 475 microns, about 350 microns and about 450 microns, and about 350 microns and about 650 microns and any value or range in between whether overlapping or not. Other lengths and/or thicknesses may be used based on the intended end-use application.

According to certain embodiments, the tube has a cross-sectional wall configuration which produces stress-resistant or stress tolerant properties. Configurations may include a circle, a rounded square, an oval, a racetrack configuration having parallel sides with full radius ends, and the like. According to certain aspects, the cross-sectional configuration has a wall to wall outer major dimension between about 0.5 mm and about 4.0 mm and a wall to wall inner minor dimension between about 0.15 mm and about 3.3 mm.

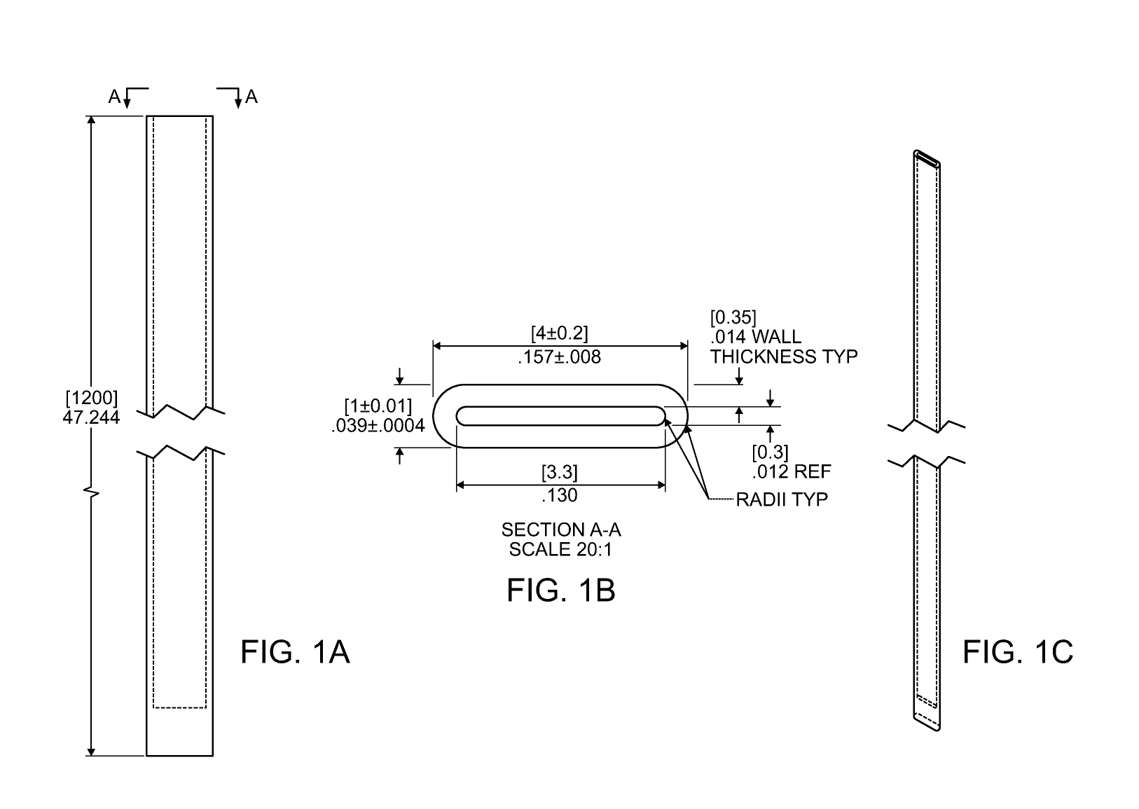

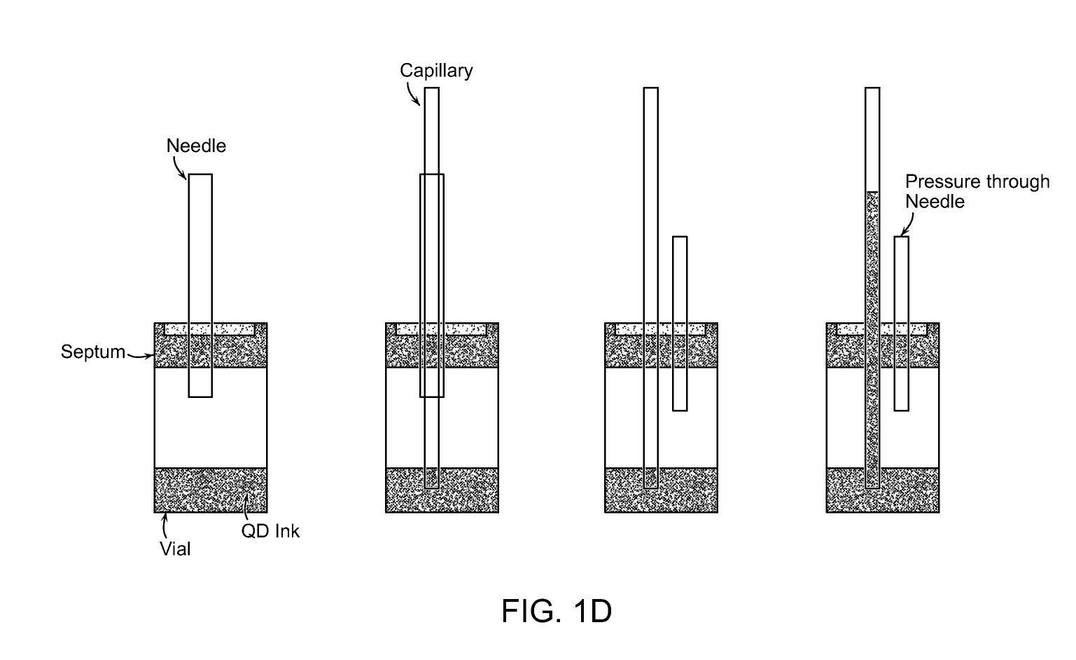

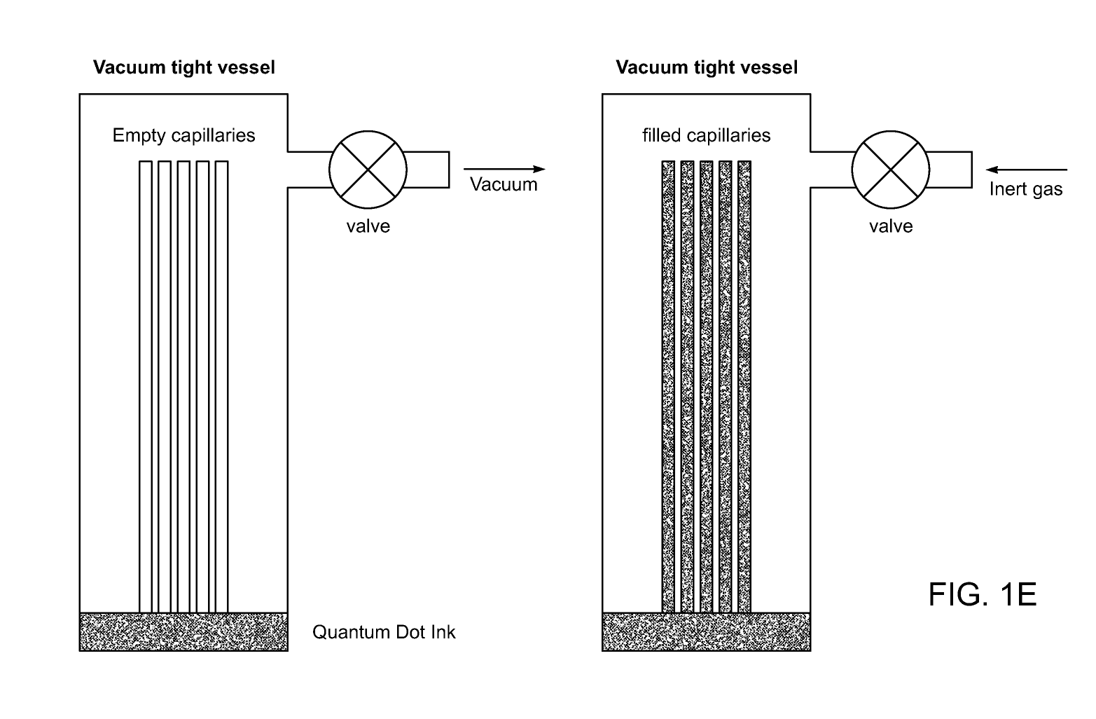

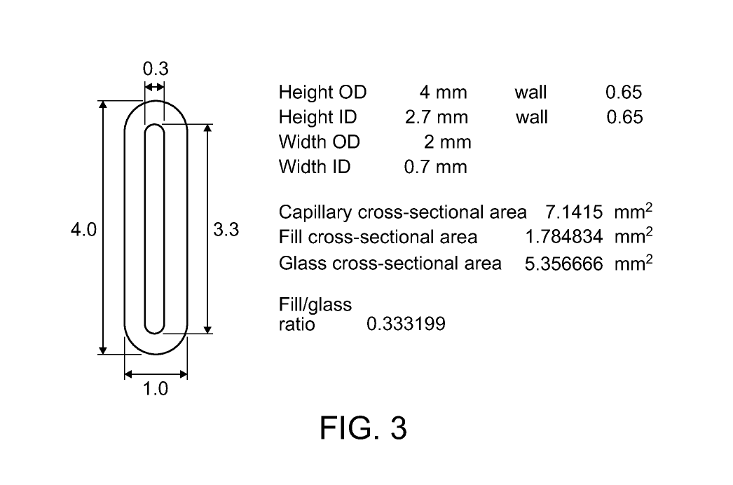

FIG. 1B depicts in schematic form a tube having a cross-sectional wall design in the configuration of a racetrack. According to this aspect, the wall of the tube includes a first full semicircle or radius end and a second full semicircle or radius end. The first full radius end and the second full radius end are connected by first and second substantially parallel walls. An exemplary tube having a cross-sectional configuration of a racetrack is characterized as being stress-resistant or stress-tolerant to the stresses or load on the tube due to polymerization and curing of a polymerizable quantum dot formulation within the tube and additional stresses from heating the tube with the polymerized quantum dot matrix therein. Such an exemplary tube is referred to herein as a stress-resistant tube or stress-tolerant tube. An exemplary tube is depicted in FIG. 3.

According to one aspect, the walls are straight or flat and provide a consistent or uniform path length through the tube and accordingly through the quantum dot matrix therein through which photons from an LED may pass. The substantially parallel and straight walls also advantageously provide a flat face to couple the tube to a corresponding flat end of a light guide plate of a back light unit. According to one aspect, the tube with the race track configuration has a cross-sectional diameter of between about 0.5 mm and about 5.0 mm in the elongate direction (major dimension) and between about 0.15 mm and about 3.3 mm in the width direction (minor dimension). One example of a suitable cross sectional diameter is about 4 mm in the elongate direction by about 1 mm in the width direction. According to one aspect, the full radius ends advantageously bear higher loads than square cornered tubes.

As can be seen in FIG. 1B, the tube has a uniform wall thickness. Such a wall thickness can be within the range of between about 60 and about 700 microns. However, it is to be understood that the wall thickness may be uniform or nonuniform, i.e. of varying thickness. For example, the full radius ends of the tube may be thicker than the straight wall portions so as to provide greater stability. One exemplary wall thickness is between about 310 microns and about 390 microns, such as about 315 microns or about 380 microns. Such a wall thickness advantageously inhibits breakage of the tube during processing. As shown in FIG. 1B, the walls define an interior volume into which quantum dots are to be provided in the form of a matrix. The interior volume is dependent upon the dimensions of the stress-resistant tube. However, suitable volumes include between about 0.0015 ml and about 2.0 ml. In addition, stress-resistant tubes of the present invention have a ratio of the cross-sectional area of the matrix to the cross-sectional area of the wall of less than or equal to about 0.35. An exemplary ratio characteristic of a stress-resistant tube is about 0.35.

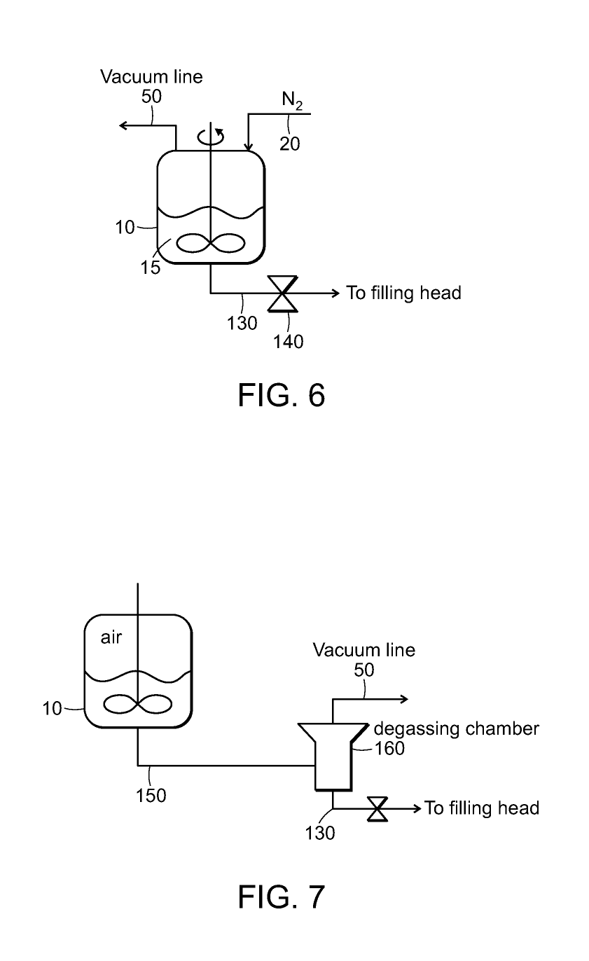

In addition to having full radius ends, capillaries of the present invention preferably have a predetermined ratio of glass wall thickness to the volume of internal matrix. Control of such ratio can allow the capillary to bear stress loads set up by both the shrinkage of the matrix monomers upon polymerization as well as the differential expansion and contraction of the polymer/glass system on thermal cycling. For example, for a capillary containing a cross-linked LMA/EGDMA matrix system (e.g., described elsewhere herein), a matrix cross sectional area to glass cross sectional area ratio below 0.35 can be preferred, although ratios as high as 0.7 can also be beneficial for capillaries prepared from direct drawn glass. FIG. 6 depicts a cross-section of a drawing of an example of an embodiment of a tube in accordance with the present invention showing dimensions related to this ratio.

According to one aspect, the length of the tube is selected based on the length of the side of the light guide plate of the backlight unit along which it is positioned. Such lengths include between about 50 mm and about 1500 mm with the optically active area spanning substantially the entire length of the tube. An exemplary length is about 1100 mm or about 1200 mm. It is to be understood that the length of the tube can be shorter than, equal to, or longer than the length of the light guide plate.

According to one aspect, one or both ends of the glass tube may be sealed. The seal can be of any size or length. One exemplary dimension is that the distance from the end of the capillary to the beginning of the optically active area is between about 2 mm to about 8 mm, with about 3 mm or 5 mm being exemplary. Sealing methods and materials are known to those of skill in the art and include glass seal, epoxy, silicone, acrylic, light or heat curable polymers and metal. A commercially available sealing material is CERASOLZER available from MBR Electronics GmbH (Switzerland). Suitable metals or metal solders useful as sealing materials to provide a hermetic seal and good glass adhesion include indium, indium tin, and indium tin and bismuth alloys, as well as eutectics of tin and bismuth. One exemplary solder includes indium #316 alloy commercially available from McMaster-Carr. Sealing using solders may be accomplished using conventional soldering irons or ultrasonic soldering baths known to those of skill in the art. Ultrasonic methods provide fluxless sealing using indium solder in particular. Seals include caps of the sealing materials having dimensions suitable to fit over and be secured to an end of the tube. According to one embodiment, one end of the tube is sealed with glass and the other end is sealed with epoxy. According to one aspect, the glass tube with a quantum dot matrix therein is hermetically sealed. Examples of sealing techniques include but are not limited to, (1) contacting an open end of a tube with an epoxy, (2) drawing the epoxy into the open end due to shrinkage action of a curing resin, or (3) covering the open end with a glass adhering metal such as a glass adhering solder or other glass adhering material, and (4) melting the open end by heating the glass above the melting point of the glass and pinching the walls together to close the opening to form a molten glass hermetic seal.

In certain embodiments, for example, a tube is filled with a liquid quantum dot formulation under oxygen free conditions, the end or ends of the tube are sealed under oxygen-free conditions and the liquid quantum dot formulation is UV cured. The filling procedures described herein may be carried out at room temperature such as between about 20° C. to about 25° C. An oxygen-free condition refers to a condition or an atmosphere where oxygen is substantially or completely absent. An oxygen-free condition can be provided by a nitrogen atmosphere or other inert gas atmosphere where oxygen is absent or substantially absent. In addition, an oxygen-free condition can be provided by placing the quantum dot formulation under vacuum.

According to one aspect, a stress-resistant tube, such as a borosilicate glass tube having a configuration described herein, is filled under oxygen free conditions with the quantum dot formulation of Example III. Accordingly, the environment within the tube and/or the quantum dot formulation within the tube is substantially or completely free of oxygen. Glass capillaries are maintained under conditions of suitable time, pressure and temperature sufficient to dry the glass capillaries. A quantum dot ink formulation of Example III is maintained in a quantum dot ink vessel under nitrogen. Dried capillaries with one end open are placed into a vacuum fill vessel with an open end down into quantum dot ink. The quantum dot ink vessel is connected to the vacuum fill vessel via tubing and valves such that ink is able to flow from the quantum dot ink vessel to the vacuum fill vessel by applying pressure differentials. The pressure within the vacuum fill vessel is reduced to less than 200 mtorr and then repressurized with nitrogen. Quantum dot ink is admitted into the vacuum fill vessel by pressurization of the quantum dot ink vessel and the capillaries are allowed to fill under oxygen free conditions. Alternatively, the vacuum fill vessel can be evacuated thereby drawing the fluid up into the capillaries. After the capillaries are filled, the system is bled to atmospheric pressure. The exterior of the capillaries are then cleaned using toluene.

According to an additional aspect, a pressure differential can be used to transfer an amount of quantum dot ink from one vessel to another. For example, and with reference to FIG. 1D, an amount of quantum dot ink can be contained in a vial or well container capped with a septum. A larger gauge needle is then introduced through the septum and into the vial. A capillary is then introduced into the vial through the needle and into the quantum ink at the bottom of the vial. The needle is then removed and the septum closes around the capillary. A pressurizing needle attached to a syringe is then introduced through the septum. Air is then introduced into the vial using the syringe which increases the pressure in the vial, which in turn forces the quantum dot ink into the capillary. Thereafter, the filled capillary is removed from the quantum ink supply and the vial and sealed at each end. Following removal, the ink included in the sealed capillary is cured. Alternatively, the ink can be cured prior to sealing.

In another embodiment, a tube can be filled by application of vacuum to draw the ink into the tube. An example of a set-up for filling a tube by application of vacuum is shown in FIG. 1E. A tube, such as a capillary tube, is sealed at one end and placed open end down in an airtight vessel. Numerous tubes can be loaded simultaneously into the same vessel. To this vessel is added enough quantum dot ink to submerge the open ends of the tubes and the vessel is sealed. Vacuum is applied and the pressure of the system is reduced to between about 1 millitorr to about 1000 millitorr. The vessel is then repressurized with nitrogen causing the capillaries to fill. A slight overpressure of gas such as between 0-60 psi, speeds filling of the tubes. The tubes are then removed from the well, cleaned and then sealed to provide a tube with a quantum dot formulation therein and having an oxygen free environment within the tube.

According to an additional embodiment, tubes can be filled with a quantum dot formulation using gravity where the quantum dot formulation is simply poured or pipetted or otherwise injected into an open upper portion of the tube which is maintained under oxygen-free conditions and the quantum dot formulation flows into the lower portion of the tube under the influence of gravity. The tube can then be sealed providing a sealed tube with a quantum dot formulation therein and with an oxygen free environment within the tube.

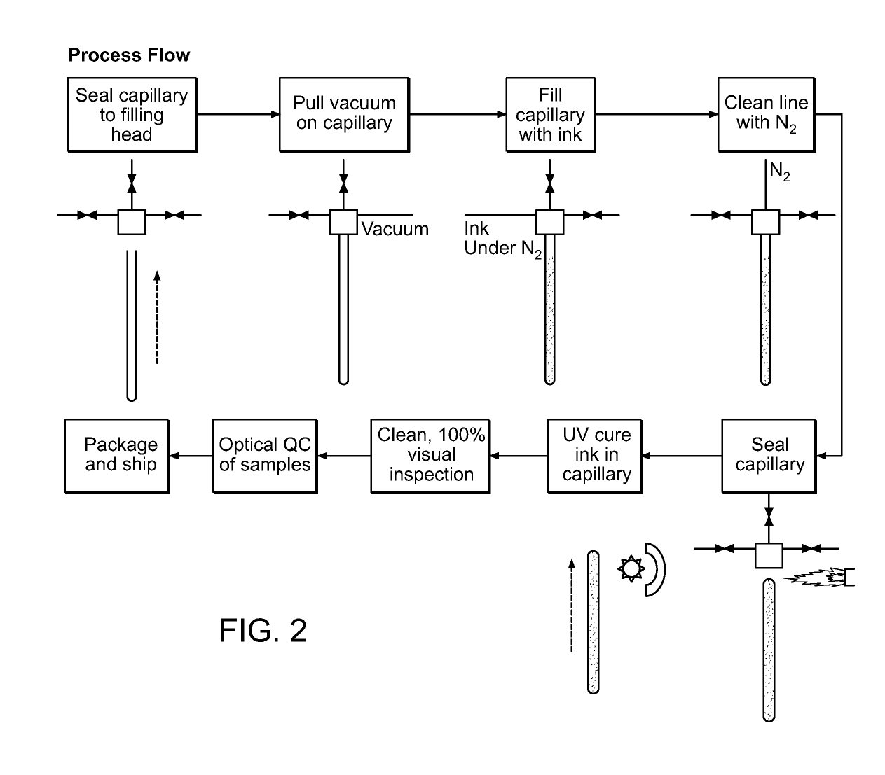

According to an additional embodiment with reference to FIG. 2, a capillary with one end sealed is connected to a filling or manifold head capable of docking with the capillary and switching between vacuum and ink fill. The capillary is evacuated by a vacuum having a vacuum capability of less than 200 mTorr. Quantum dot ink under nitrogen pressure is then filled into the capillary. The quantum dot ink or formulation is under an oxygen-free condition, i.e., oxygen is substantially or completely absent. The lines and filling head are flushed with nitrogen. The capillary is held under an atmosphere of nitrogen or vacuum and the end sealed, such as by melting the capillary end and sealing, for example by a capillary sealing system. The ink may then be cured in the capillary using UV light in a UV curing apparatus for curing quantum dot ink.

In certain embodiments, for example, the quantum dot formulation within the vessel or tube or capillary completely or substantially lacks oxygen and can be cured with an H or D bulb emitting 900-1000 mjoules/cm2 with a total dosage over about 1 to about 5 minutes. Alternatively, curing can be accomplished using a Dymax 500EC UV Curing Flood system equipped with a mercury UVB bulb. In such case, a lamp intensity (measured as 33 mW/cm2 at a distance of about 7″ from the lamp housing) can be effective, with the capillary being cured for 10-15 seconds on each side while being kept at a distance of 7 inches from the lamp housing. After curing, the edges of the capillary can be sealed thereby providing a cured quantum dot formulation under oxygen free conditions.

In certain embodiments relating to a temporary seal, sealing can comprise using an optical adhesive or silicone to seal one or both ends or edges of the capillary. For example, a drop of optical adhesive can be placed on each edge of the capillary and cured. An example of an optical adhesive includes, but is not limited to, NOA-68T obtainable from Norland Optics. For example, a drop of such adhesive can be placed on each edge of the capillary and cured (e.g., for 20 seconds with a Rolence Enterprise Model Q-Lux-UV lamp).

In certain embodiments, sealing can comprise using glass to seal one or both ends or edges of the capillary. This can be done by briefly bringing a capillary filled with cured quantum dot ink into brief contact with an oxygen/Mapp gas flame until the glass flows and seals the end. Oxygen-hydrogen flames may be used as well as any other mixed gas flame. The heat may also be supplied by laser eliminating the need for an open flame. In certain embodiments, both ends of a capillary filled with uncured quantum dot ink under oxygen-free conditions can be sealed, allowing the ink to then be photocured in the sealed capillary.

In certain embodiments, the capillary is hermetically sealed, i.e., impervious to gases and moisture, thereby providing a sealed capillary where oxygen is substantially or completely absent within the sealed capillary.

In certain embodiments, the capillary is pseudo-hermetically sealed, i.e., at least partially impervious to gases and moisture.

Other suitable techniques can be used for sealing the ends or edges of the capillary.

In certain aspects and embodiments of the inventions taught herein, the stress-resistant tube including the cured quantum dot formulation (optical material) may optionally be exposed to light flux for a period of time sufficient to increase the photoluminescent efficiency of the optical material.

In certain embodiments, the optical material is exposed to light and heat for a period of time sufficient to increase the photoluminescent efficiency of the optical material.

In preferred certain embodiments, the exposure to light or light and heat is continued for a period of time until the photoluminescent efficiency reaches a substantially constant value.

In one embodiment, for example, after the optic is filled with quantum dot containing ink under oxygen free conditions, cured, and sealed (regardless of the order in which the curing and sealing steps are conducted), the optic is exposed, to 25-35 mW/cm2 light flux with a wavelength in a range from about 365 nm to about 470 nm, while at a temperature of in a range from about 25° C. to about 80° C., for a period of time sufficient to increase the photoluminescent efficiency of the ink. In one embodiment, for example, the light has a wavelength of about 450 nm, the light flux is 30 mW/cm2, the temperature 80° C., and the exposure time is 3 hours. Alternatively, the quantum dot containing ink can be cured within the tube before sealing one or both ends of the tube.

According to one aspect of the present invention, a polymerizable composition including quantum dots is provided. Quantum dots may be present in the polymerizable composition in an amount from about 0.05% w/w to about 5.0% w/w. According to one aspect, the polymerizable composition is photopolymerizable. The polymerizable composition is in the form of a fluid which can be placed within the tube under oxygen-free conditions and then one or both ends sealed with the tube being hermetically sealed to avoid oxygen being within the tube. The polymerizable composition is then subjected to light of sufficient intensity and for a period of time sufficient to polymerize the polymerizable composition, and in one aspect, in the absence of oxygen. The period of time can range between about 10 seconds to about 6 minutes or between about 1 minute to about 6 minutes. According to one embodiment, the period of time is sufficiently short to avoid agglomeration of the quantum dots prior to formation of a polymerized matrix. Agglomeration can result in FRET and subsequent loss of photoluminescent performance.

The polymerizable composition includes quantum dots in combination with one or more of a polymerizable composition. According to one aspect, the polymerizable composition avoids, resists or inhibits yellowing when in the form of a matrix, such as a polymerized matrix. A matrix in which quantum dots are dispersed may be referred to as a host material. Host materials include polymeric and non-polymeric materials that are at least partially transparent, and preferably fully transparent, to preselected wavelengths of light.

According to an additional aspect, the polymerizable composition is selected so as to provide sufficient ductility to the polymerized matrix. Ductility is advantageous in relieving the stresses on the tube that occur during polymer shrinkage when the polymer matrix is cured. Suitable polymerizable compositions act as solvents for the quantum dots and so combinations of polymerizable compositions can be selected based on solvent properties for various quantum dots.

Polymerizable compositions include monomers and oligomers and polymers and mixtures thereof. Exemplary monomers include lauryl methacrylate, norbornyl methacrylate, Ebecyl 150 (Cytec), CD590 (Cytec) and the like. Polymerizable materials can be present in the polymerizable formulation in an amount greater than 50 weight percent. Examples include amounts in a range greater than 50 to about 99.5 weight percent, greater than 50 to about 98 weight percent, greater than 50 to about 95 weight percent, from about 80 to about 99.5 weight percent, from about 90 to about 99.95 weight percent, from about 95 to about 99.95 weight percent. Other amounts outside these examples may also be determined to be useful or desirable.

Exemplary polymerizable compositions further include one or more of a crosslinking agent, a scattering agent, a rheology modifier, a filler, and a photoinitiator.

Suitable crosslinking agents include ethylene glycol dimethacrylate, Ebecyl 150 and the like. Crosslinking agents can be present in the polymerizable formulation in an amount between about 0.5 wt % and about 3.0 wt %. Crosslinking agents are generally added, for example in an amount of 1% w/w, to improve stability and strength of a polymer matrix which helps avoid cracking of the matrix due to shrinkage upon curing of the matrix.

Suitable scattering agents include TiO2, alumina, barium sulfate, PTFE, barium titanate and the like. Scattering agents can be present in the polymerizable formulation in an amount between about 0.05 wt % and about 1.0 wt %. Scattering agents are generally added, for example in a preferred amount of about 0.15% w/w, to promote outcoupling of emitted light.

Suitable rheology modifiers (thixotropes) include fumed silica commercially available from Cabot Corporation such as TS-720 treated fumed silica, treated silica commercially available from Cabot Corporation such as TS720, TS500, TS530, TS610 and hydrophilic silica such as M5 and EHS commercially available from Cabot Corporation. Rheology modifiers can be present in the polymerizable formulation in an amount between about 0.5% w/w to about 12% w/w. Rheology modifiers or thixotropes act to lower the shrinkage of the matrix resin and help prevent cracking. Hydrophobic rheology modifiers disperse more easily and build viscosity at higher loadings allowing for more filler content and less shrinkage to the point where the formulation becomes too viscous to fill the tube. Rheology modifiers such as fumed silica also provide higher EQE and help to prevent settling of TiO2 on the surface of the tube before polymerization has taken place.

Suitable fillers include silica, fumed silica, precipitated silica, glass beads, PMMA beads and the like. Fillers can be present in the polymerizable formulation in an amount between about 0.01% and about 60%, about 0.01% and about 50%, about 0.01% and about 40%, about 0.01% and about 30%, about 0.01% and about 20% and any value or range in between whether overlapping or not.

Suitable photoinitiators include Irgacure 2022, KTO-46 (Lambert), Esacure 1 (Lambert) and the like. Photoinitiators can be present in the polymerizable formulation in an amount between about 1% w/w to about 5% w/w. Photoinitiators generally help to sensitize the polymerizable composition to UV light for photopolymerization.

According to additional aspects, quantum dots are nanometer sized particles that can have optical properties arising from quantum confinement. The particular composition(s), structure, and/or size of a quantum dot can be selected to achieve the desired wavelength of light to be emitted from the quantum dot upon stimulation with a particular excitation source. In essence, quantum dots may be tuned to emit light across the visible spectrum by changing their size. See C. B. Murray, C. R. Kagan, and M. G. Bawendi, Annual Review of Material Sci., 2000, 30: 545-610 hereby incorporated by reference in its entirety.

Quantum dots can have an average particle size in a range from about 1 to about 1000 nanometers (nm), and preferably in a range from about 1 to about 100 nm. In certain embodiments, quantum dots have an average particle size in a range from about 1 to about 20 nm (e.g., such as about 5, 6, 7, 8, 9, 10, 11, 12, 13, 14, 15, 16, 17, 18, 19, or 20 nm). In certain embodiments, quantum dots have an average particle size in a range from about 1 to about 10 nm. Quantum dots can have an average diameter less than about 150 Angstroms (\acute{Å}). In certain embodiments, quantum dots having an average diameter in a range from about 12 to about 150 \acute{Å} can be particularly desirable. However, depending upon the composition, structure, and desired emission wavelength of the quantum dot, the average diameter may be outside of these ranges.

Preferably, a quantum dot comprises a semiconductor nanocrystal. In certain embodiments, a semiconductor nanocrystal has an average particle size in a range from about 1 to about 20 nm, and preferably from about 1 to about 10 nm. However, depending upon the composition, structure, and desired emission wavelength of the quantum dot, the average diameter may be outside of these ranges.

A quantum dot can comprise one or more semiconductor materials.

Examples of semiconductor materials that can be included in a quantum dot (including, e.g., semiconductor nanocrystal) include, but are not limited to, a Group IV element, a Group II-VI compound, a Group II-V compound, a Group III-VI compound, a Group III-V compound, a Group IV-VI compound, a Group compound, a Group II-IV-VI compound, a Group II-IV-V compound, an alloy including any of the foregoing, and/or a mixture including any of the foregoing, including ternary and quaternary mixtures or alloys. A non-limiting list of examples include ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

In certain embodiments, quantum dots can comprise a core comprising one or more semiconductor materials and a shell comprising one or more semiconductor materials, wherein the shell is disposed over at least a portion, and preferably all, of the outer surface of the core. A quantum dot including a core and shell is also referred to as a “core/shell” structure.

For example, a quantum dot can include a core having the formula MX, where M is cadmium, zinc, magnesium, mercury, aluminum, gallium, indium, thallium, or mixtures thereof, and X is oxygen, sulfur, selenium, tellurium, nitrogen, phosphorus, arsenic, antimony, or mixtures thereof. Examples of materials suitable for use as quantum dot cores include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

A shell can be a semiconductor material having a composition that is the same as or different from the composition of the core. The shell can comprise an overcoat including one or more semiconductor materials on a surface of the core. Examples of semiconductor materials that can be included in a shell include, but are not limited to, a Group IV element, a Group II-VI compound, a Group II-V compound, a Group III-VI compound, a Group III-V compound, a Group IV-VI compound, a Group I-III-VI compound, a Group II-IV-VI compound, a Group II-IV-V compound, alloys including any of the foregoing, and/or mixtures including any of the foregoing, including ternary and quaternary mixtures or alloys. Examples include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing. For example, ZnS, ZnSe or CdS overcoatings can be grown on CdSe or CdTe semiconductor nanocrystals.

In a core/shell quantum dot, the shell or overcoating may comprise one or more layers. The overcoating can comprise at least one semiconductor material which is the same as or different from the composition of the core. Preferably, the overcoating has a thickness from about one to about ten monolayers. An overcoating can also have a thickness greater than ten monolayers. In certain embodiments, more than one overcoating can be included on a core.

In certain embodiments, the surrounding “shell” material can have a band gap greater than the band gap of the core material. In certain other embodiments, the surrounding shell material can have a band gap less than the band gap of the core material.

In certain embodiments, the shell can be chosen so as to have an atomic spacing close to that of the “core” substrate. In certain other embodiments, the shell and core materials can have the same crystal structure.

Examples of quantum dot (e.g., semiconductor nanocrystal) (core)shell materials include, without limitation: red (e.g., (CdSe)CdZnS (core)shell), green (e.g., (CdZnSe)CdZnS (core)shell, etc.), and blue (e.g., (CdS)CdZnS (core)shell.

Quantum dots can have various shapes, including, but not limited to, sphere, rod, disk, other shapes, and mixtures of various shaped particles.

One example of a method of manufacturing a quantum dot (including, for example, but not limited to, a semiconductor nanocrystal) is a colloidal growth process. Colloidal growth occurs by injection an M donor and an X donor into a hot coordinating solvent. One example of a preferred method for preparing monodisperse quantum dots comprises pyrolysis of organometallic reagents, such as dimethyl cadmium, injected into a hot, coordinating solvent. This permits discrete nucleation and results in the controlled growth of macroscopic quantities of quantum dots. The injection produces a nucleus that can be grown in a controlled manner to form a quantum dot. The reaction mixture can be gently heated to grow and anneal the quantum dot. Both the average size and the size distribution of the quantum dots in a sample are dependent on the growth temperature. The growth temperature for maintaining steady growth increases with increasing average crystal size. Resulting quantum dots are members of a population of quantum dots. As a result of the discrete nucleation and controlled growth, the population of quantum dots that can be obtained has a narrow, monodisperse distribution of diameters. The monodisperse distribution of diameters can also be referred to as a size. Preferably, a monodisperse population of particles includes a population of particles wherein at least about 60% of the particles in the population fall within a specified particle size range. A population of monodisperse particles preferably deviate less than 15% rms (root-mean-square) in diameter and more preferably less than 10% rms and most preferably less than 5%.

An example of an overcoating process is described, for example, in U.S. Pat. No. 6,322,901. By adjusting the temperature of the reaction mixture during overcoating and monitoring the absorption spectrum of the core, overcoated materials having high emission quantum efficiencies and narrow size distributions can be obtained.

The narrow size distribution of the quantum dots (including, e.g., semiconductor nanocrystals) allows the possibility of light emission in narrow spectral widths. Monodisperse semiconductor nanocrystals have been described in detail in Murray et al. (J. Am. Chem. Soc., 115:8706 (1993)); in the thesis of Christopher Murray, and “Synthesis and Characterization of II-VI Quantum Dots and Their Assembly into 3-D Quantum Dot Superlattices”, Massachusetts Institute of Technology, September, 1995. The foregoing are hereby incorporated herein by reference in their entireties.

The process of controlled growth and annealing of the quantum dots in the coordinating solvent that follows nucleation can also result in uniform surface derivatization and regular core structures. As the size distribution sharpens, the temperature can be raised to maintain steady growth. By adding more M donor or X donor, the growth period can be shortened. The M donor can be an inorganic compound, an organometallic compound, or elemental metal. For example, an M donor can comprise cadmium, zinc, magnesium, mercury, aluminum, gallium, indium or thallium, and the X donor can comprise a compound capable of reacting with the M donor to form a material with the general formula MX. The X donor can comprise a chalcogenide donor or a pnictide donor, such as a phosphine chalcogenide, a bis(silyl) chalcogenide, dioxygen, an ammonium salt, or a tris(silyl) pnictide. Suitable X donors include, for example, but are not limited to, dioxygen, bis(trimethylsilyl) selenide ((TMS)2Se), trialkyl phosphine selenides such as (tri-noctylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl)telluride ((TMS)2Te), bis(trimethylsilyl)sulfide ((TMS)2S), a trialkyl phosphine sulfide such as (tri-noctylphosphine) sulfide (TOPS), an ammonium salt such as an ammonium halide (e.g., NH4Cl), tris(trimethylsilyl)phosphide ((TMS)3P), tris(trimethylsilyl) arsenide ((TMS)3As), or tris(trimethylsilyl) antimonide ((TMS)3Sb). In certain embodiments, the M donor and the X donor can be moieties within the same molecule.

A coordinating solvent can help control the growth of the quantum dot. A coordinating solvent is a compound having a donor lone pair that, for example, a lone electron pair available to coordinate to a surface of the growing quantum dot (including, e.g., a semiconductor nanocrystal). Solvent coordination can stabilize the growing quantum dot. Examples of coordinating solvents include alkyl phosphines, alkyl phosphine oxides, alkyl phosphonic acids, or alkyl phosphinic acids, however, other coordinating solvents, such as pyridines, furans, and amines may also be suitable for the quantum dot (e.g., semiconductor nanocrystal) production. Additional examples of suitable coordinating solvents include pyridine, tri-n-octyl phosphine (TOP), tri-n-octyl phosphine oxide (TOPO) and trishydroxylpropylphosphine (tHPP), tributylphosphine, tri(dodecyl)phosphine, dibutyl-phosphite, tributyl phosphite, trioctadecyl phosphite, trilauryl phosphite, tris(tridecyl)phosphite, triisodecyl phosphite, bis(2-ethylhexyl)phosphate, tris(tridecyl)phosphate, hexadecylamine, oleylamine, octadecylamine, bis(2-ethylhexyl)amine, octylamine, dioctylamine, trioctylamine, dodecylamine/laurylamine, didodecylamine tridodecylamine, hexadecylamine, dioctadecylamine, trioctadecylamine, phenylphosphonic acid, hexylphosphonic acid, tetradecylphosphonic acid, octylphosphonic acid, octadecylphosphonic acid, propylenediphosphonic acid, phenylphosphonic acid, aminohexylphosphonic acid, dioctyl ether, diphenyl ether, methyl myristate, octyl octanoate, and hexyl octanoate. In certain embodiments, technical grade TOPO can be used.

In certain embodiments, quantum dots can alternatively be prepared with use of non-coordinating solvent(s).

Size distribution during the growth stage of the reaction can be estimated by monitoring the absorption or emission line widths of the particles. Modification of the reaction temperature in response to changes in the absorption spectrum of the particles allows the maintenance of a sharp particle size distribution during growth. Reactants can be added to the nucleation solution during crystal growth to grow larger crystals. For example, for CdSe and CdTe, by stopping growth at a particular semiconductor nanocrystal average diameter and choosing the proper composition of the semiconducting material, the emission spectra of the semiconductor nanocrystals can be tuned continuously over the wavelength range of 300 nm to 5 microns, or from 400 nm to 800 nm.

The particle size distribution of the quantum dots (including, e.g., semiconductor nanocrystals) can be further refined by size selective precipitation with a poor solvent for the quantum dots, such as methanol/butanol. For example, quantum dots can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected quantum dot (e.g., semiconductor nanocrystal) population preferably has no more than a 15% rms deviation from mean diameter, more preferably 10% rms deviation or less, and most preferably 5% rms deviation or less.

Semiconductor nanocrystals and other types of quantum dots preferably have ligands attached thereto. According to one aspect, quantum dots within the scope of the present invention include green CdSe quantum dots having oleic acid ligands and red CdSe quantum dots having oleic acid ligands. Alternatively, or in addition, octadecylphosphonic acid (“ODPA”) ligands may be used instead of oleic acid ligands. The ligands promote solubility of the quantum dots in the polymerizable composition which allows higher loadings without agglomeration which can lead to red shifting.

Ligands can be derived from a coordinating solvent that may be included in the reaction mixture during the growth process.

Ligands can be added to the reaction mixture.

Ligands can be derived from a reagent or precursor included in the reaction mixture for synthesizing the quantum dots.

In certain embodiments, quantum dots can include more than one type of ligand attached to an outer surface.

A quantum dot surface that includes ligands derived from the growth process or otherwise can be modified by repeated exposure to an excess of a competing ligand group (including, e.g., but not limited to, coordinating group) to form an overlayer. For example, a dispersion of the capped quantum dots can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the nanoparticle, including, for example, but not limited to, phosphines, thiols, amines and phosphates.

For example, a quantum dot can be exposed to short chain polymers which exhibit an affinity for the surface and which terminate in a moiety having an affinity for a suspension or dispersion medium. Such affinity improves the stability of the suspension, and discourages flocculation of the quantum dot. Examples of additional ligands include fatty acid ligands, long chain fatty acid ligands, alkyl phosphines, alkyl phosphine oxides, alkyl phosphonic acids, or alkyl phosphinic acids, pyridines, furans, and amines. More specific examples include, but are not limited to, pyridine, tri-n-octyl phosphine (TOP), tri-n-octyl phosphine oxide (TOPO), tris-hydroxylpropylphosphine (tHPP) and octadecylphosphonic acid (“ODPA”). Technical grade TOPO can be used.

Suitable coordinating ligands can be purchased commercially or prepared by ordinary synthetic organic techniques, for example, as described in J. March, Advanced Organic Chemistry, which is incorporated herein by reference in its entirety.

The emission from a quantum dot capable of emitting light can be a narrow Gaussian emission band that can be tuned through the complete wavelength range of the ultraviolet, visible, or infra-red regions of the spectrum by varying the size of the quantum dot, the composition of the quantum dot, or both. For example, a semiconductor nanocrystal comprising CdSe can be tuned in the visible region; a semiconductor nanocrystal comprising InAs can be tuned in the infra-red region. The narrow size distribution of a population of quantum dots capable of emitting light can result in emission of light in a narrow spectral range. The population can be monodisperse preferably exhibits less than a 15% rms (root-mean-square) deviation in diameter of such quantum dots, more preferably less than 10%, most preferably less than 5%. Spectral emissions in a narrow range of no greater than about 75 nm, preferably no greater than about 60 nm, more preferably no greater than about 40 nm, and most preferably no greater than about 30 nm full width at half max (FWHM) for such quantum dots that emit in the visible can be observed. IR-emitting quantum dots can have a FWHM of no greater than 150 nm, or no greater than 100 nm. Expressed in terms of the energy of the emission, the emission can have a FWHM of no greater than 0.05 eV, or no greater than 0.03 eV. The breadth of the emission decreases as the dispersity of the light-emitting quantum dot diameters decreases.

Quantum dots can have emission quantum efficiencies such as greater than 10%, 20%, 30%, 40%, 50%, 60%, 70%, 80%, or 90%.

The narrow FWHM of quantum dots can result in saturated color emission. The broadly tunable, saturated color emission over the entire visible spectrum of a single material system is unmatched by any class of organic chromophores (see, for example, Dabbousi et al., J. Phys. Chem. 101, 9463 (1997), which is incorporated by reference in its entirety). A monodisperse population of quantum dots will emit light spanning a narrow range of wavelengths.

Useful quantum dots according to the present invention are those that emit wavelengths characteristic of red light. In certain preferred embodiments, quantum dots capable of emitting red light emit light having a peak center wavelength in a range from about 615 nm to about 635 nm, and any wavelength or range in between whether overlapping or not. For example, the quantum dots can be capable or emitting red light having a peak center wavelength of about 635 nm, about 630 nm, of about 625 nm, of about 620 nm, of about 615 nm.

Useful quantum dots according to the present invention are also those that emit wavelength characteristic of green light. In certain preferred embodiments, quantum dots capable of emitting green light emit light having a peak center wavelength in a range from about 520 nm to about 545 nm, and any wavelength or range in between whether overlapping or not. For example, the quantum dots can be capable or emitting green light having a peak center wavelength of about 520 nm, of about 525 nm, of about 535 nm, of about 540 nm or of about 540 nm.

According to further aspects of the present invention, the quantum dots exhibit a narrow emission profile in the range of between about 23 nm and about 60 nm at full width half maximum (FWHM). The narrow emission profile of quantum dots of the present invention allows the tuning of the quantum dots and mixtures of quantum dots to emit saturated colors thereby increasing color gamut and power efficiency beyond that of conventional LED lighting displays. According to one aspect, green quantum dots designed to emit a predominant wavelength of for example, about 523 nm and having an emission profile with a FWHM of about, for example, 37 nm are combined, mixed or otherwise used in combination with red quantum dots designed to emit a predominant wavelength of about, for example, 617 nm and having an emission profile with a FWHM of about, for example 32 nm. Such combinations can be stimulated by blue light to create trichromatic white light.

Quantum dots in accordance with the present invention can be included in various formulations depending upon the desired utility. According to one aspect, quantum dots are included in flowable formulations or liquids to be included, for example, into clear vessels, such as the stress-resistant tubes described herein, which are to be exposed to light. Such formulations can include various amounts of one or more type of quantum dots and one or more host materials. Such formulations can further include one or more scatterers. Other optional additives or ingredients can also be included in a formulation. In certain embodiments, a formulation can further include one or more photo initiators. One of skill in the art will readily recognize from the present invention that additional ingredients can be included depending upon the particular intended application for the quantum dots.

An optical material or formulation within the scope of the invention may include a host material, such as can be included in an optical component described herein, which may be present in an amount from about 50 weight percent and about 99.5 weight percent, and any weight percent in between whether overlapping or not. In certain embodiment, a host material may be present in an amount from about 80 to about 99.5 weight percent. Examples of specific useful host materials include, but are not limited to, polymers, oligomers, monomers, resins, binders, glasses, metal oxides, and other nonpolymeric materials. Preferred host materials include polymeric and non-polymeric materials that are at least partially transparent, and preferably fully transparent, to preselected wavelengths of light. In certain embodiments, the preselected wavelengths can include wavelengths of light in the visible (e.g., 400-700 nm) region of the electromagnetic spectrum. Preferred host materials include cross-linked polymers and solvent-cast polymers. Examples of other preferred host materials include, but are not limited to, glass or a transparent resin. In particular, a resin such as a non-curable resin, heat-curable resin, or photocurable resin is suitably used from the viewpoint of processability. Specific examples of such a resin, in the form of either an oligomer or a polymer, include, but are not limited to, a melamine resin, a phenol resin, an alkyl resin, an epoxy resin, a polyurethane resin, a maleic resin, a polyamide resin, polymethyl methacrylate, polyacrylate, polycarbonate, polyvinyl alcohol, polyvinylpyrrolidone, hydroxyethylcellulose, carboxymethylcellulose, copolymers containing monomers or oligomers forming these resins, and the like. Other suitable host materials can be identified by persons of ordinary skill in the relevant art.

Host materials can also comprise silicone materials. Suitable host materials comprising silicone materials can be identified by persons of ordinary skill in the relevant art.

In certain embodiments and aspects of the inventions contemplated by this invention, a host material comprises a photocurable resin. A photocurable resin may be a preferred host material in certain embodiments, e.g., in embodiments in which the composition is to be patterned. As a photo-curable resin, a photo-polymerizable resin such as an acrylic acid or methacrylic acid based resin containing a reactive vinyl group, a photo-crosslinkable resin which generally contains a photo-sensitizer, such as polyvinyl cinnamate, benzophenone, or the like may be used. A heat-curable resin may be used when the photo-sensitizer is not used. These resins may be used individually or in combination of two or more.

In certain embodiments, a host material can comprise a solvent-cast resin. A polymer such as a polyurethane resin, a maleic resin, a polyamide resin, polymethyl methacrylate, polyacrylate, polycarbonate, polyvinyl alcohol, polyvinylpyrrolidone, hydroxyethylcellulose, carboxymethylcellulose, copolymers containing monomers or oligomers forming these resins, and the like can be dissolved in solvents known to those skilled in the art. Upon evaporation of the solvent, the resin forms a solid host material for the semiconductor nanoparticles.

In certain embodiments, acrylate monomers and/or acrylate oligomers which are commercially available from Radcure and Sartomer can be preferred.

Quantum dots can be encapsulated. Nonlimiting examples of encapsulation materials, related methods, and other information that may be useful are described in International Application No. PCT/US2009/01372 of Linton, filed 4 Mar. 2009 entitled “Particles Including Nanoparticles, Uses Thereof, And Methods” and U.S. Patent Application No. 61/240,932 of Nick et al., filed 9 Sep. 2009 entitled “Particles Including Nanoparticles, Uses Thereof, And Methods”, each of the foregoing being hereby incorporated herein by reference in its entirety.

The total amount of quantum dots included in an optical material, such as a host material for example a polymer matrix, within the scope of the invention is preferably in a range from about 0.05 weight percent to about 5 weight percent, and more preferably in a range from about 0.1 weight percent to about 5 weight percent and any value or range in between whether overlapping or not. The amount of quantum dots included in an optical material can vary within such range depending upon the application and the form in which the quantum dots are included (e.g., film, optics (e.g., capillary), encapsulated film, etc.), which can be chosen based on the particular end application. For instance, when an optic material is used in a thicker capillary with a longer pathlength (e.g., such as in BLUs for large screen television applications), the concentration of quantum dots can be closer to 0.5%. When an optical material is used in a thinner capillary with a shorter pathlength (e.g., such as in BLUs for mobile or hand-held applications), the concentration of quantum dots can be closer to 5%.

The ratio of quantum dots used in an optical material is determined by the emission peaks of the quantum dots used. For example, when quantum dots capable of emitting green light having a peak center wavelength in a range from about 514 nm to about 545 nm, and any wavelength in between whether overlapping or not, and quantum dots capable of emitting red light having a peak center wavelength in a range from about 615 nm to about 640 nm, and any wavelength in between whether overlapping or not, are used in an optical material, the ratio of the weight percent green-emitting quantum dots to the weight percent of red-emitting quantum dots can be in a range from about 12:1 to about 1:1, and any ratio in between whether overlapping or not.

The above ratio of weight percent green-emitting quantum dots to weight percent red-emitting quantum dots in an optical material can alternatively be presented as a molar ratio. For example, the above weight percent ratio of green to red quantum dots range can correspond to a green to red quantum dot molar ratio in a range from about 24.75 to 1 to about 5.5 to 1, and any ratio in between whether overlapping or not.

The ratio of the blue to green to red light output intensity in white trichromatic light emitted by a quantum dot containing BLU described herein including blue-emitting solid state inorganic semiconductor light emitting devices (having blue light with a peak center wavelength in a range from about 450 nm to about 460 nm, and any wavelength in between whether overlapping or not), and an optical material including mixtures of green-emitting quantum dots and red-emitting quantum dots within the above range of weight percent ratios can vary within the range. For example, the ratio of blue to green light output intensity therefor can be in a range from about 0.75 to about 4 and the ratio of green to red light output intensity therefor can be in a range from about 0.75 to about 2.0. In certain embodiments, for example, the ratio of blue to green light output intensity can be in a range from about 1.0 to about 2.5 and the ratio of green to red light output intensity can be in a range from about 0.9 to about 1.3.

Scatterers, also referred to as scattering agents, within the scope of the invention may be present, for example, in an amount of between about 0.01 weight percent and about 1 weight percent. Amounts of scatterers outside such range may also be useful. Examples of light scatterers (also referred to herein as scatterers or light scattering particles) that can be used in the embodiments and aspects of the inventions described herein, include, without limitation, metal or metal oxide particles, air bubbles, and glass and polymeric beads (solid or hollow). Other light scatterers can be readily identified by those of ordinary skill in the art. In certain embodiments, scatterers have a spherical shape. Preferred examples of scattering particles include, but are not limited to, TiO2, SiO2, BaTiO3, BaSO4, and ZnO. Particles of other materials that are non-reactive with the host material and that can increase the absorption pathlength of the excitation light in the host material can be used. In certain embodiments, light scatterers may have a high index of refraction (e.g., TiO2, BaSO4, etc) or a low index of refraction (gas bubbles).

Selection of the size and size distribution of the scatterers is readily determinable by those of ordinary skill in the art. The size and size distribution can be based upon the refractive index mismatch of the scattering particle and the host material in which the light scatterers are to be dispersed, and the preselected wavelength(s) to be scattered according to Rayleigh scattering theory. The surface of the scattering particle may further be treated to improve dispersability and stability in the host material. In one embodiment, the scattering particle comprises TiO2 (R902+ from DuPont) of 0.2 μm particle size, in a concentration in a range from about 0.01 to about 1% by weight.

The amount of scatterers in a formulation is useful in applications where the ink is contained in a clear vessel having edges to limit losses due the total internal reflection. The amount of the scatterers may be altered relative to the amount of quantum dots used in the formulation. For example, when the amount of the scatter is increased, the amount of quantum dots may be decreased.

Examples of thixotropes which may be included in a quantum dot formulation, also referred to as rheology modifiers, include, but are not limited to, fumed metal oxides (e.g., fumed silica which can be surface treated or untreated (such as Cab-O-Sil™ fumed silica products available from Cabot Corporation), fumed metal oxide gels (e.g., a silica gel). An optical material can include an amount of thixotrope in a range from about 0.5 to about 12 weight percent or from about 5 to about 12 weight percent. Other amounts outside the range may also be determined to be useful or desirable.

In certain embodiments, a formulation including quantum dots and a host material can be formed from an ink comprising quantum dots and a liquid vehicle, wherein the liquid vehicle comprises a composition including one or more functional groups that are capable of being cross-linked. The functional units can be cross-linked, for example, by UV treatment, thermal treatment, or another cross-linking technique readily ascertainable by a person of ordinary skill in a relevant art. In certain embodiments, the composition including one or more functional groups that are capable of being cross-linked can be the liquid vehicle itself. In certain embodiments, it can be a co-solvent. In certain embodiments, it can be a component of a mixture with the liquid vehicle.

One particular example of a preferred method of making an ink is as follows. A solution including quantum dots having the desired emission characteristics well dispersed in an organic solvent is concentrated to the consistency of a wax by first stripping off the solvent under nitrogen/vacuum until a quantum dot containing residue with the desired consistency is obtained. The desired resin monomer is then added under nitrogen conditions, until the desired monomer to quantum dot ratio is achieved. This mixture is then vortex mixed under oxygen free conditions until the quantum dots are well dispersed. The final components of the resin are then added to the quantum dot dispersion, and are then sonicated mixed to ensure a fine dispersion.

A tube or capillary comprising an optical material prepared from such finished ink can be prepared by then introducing the ink into the tube via a wide variety of methods, and then UV cured under intense illumination for some number of seconds for a complete cure. According to one aspect, the ink is introduced into the tube under oxygen-free conditions.

In certain aspects and embodiments of the inventions taught herein, the optic including the cured quantum dot containing ink is exposed to light flux for a period of time sufficient to increase the photoluminescent efficiency of the optical material.

In certain embodiments, the optical material is exposed to light and heat for a period of time sufficient to increase the photoluminescent efficiency of the optical material.

In preferred certain embodiments, the exposure to light or light and heat is continued for a period of time until the photoluminescent efficiency reaches a substantially constant value.

In one embodiment, for example, after the optic, i.e. tube or capillary, is filled with quantum dot containing ink under oxygen free conditions, cured, and sealed (regardless of the order in which the curing and sealing steps are conducted) to produce an optic having no or substantially no oxygen within the sealed optic, the optic is exposed to 25-35 mW/cm2 light flux with a wavelength in a range from about 365 nm to about 470 nm while at a temperature of in a range from about 25 to 80° C., for a period of time sufficient to increase the photoluminescent efficiency of the ink. In one embodiment, for example, the light has a wavelength of about 450 nm, the light flux is 30 mW/cm2, the temperature 80° C., and the exposure time is 3 hours.

Additional information that may be useful in connection with the present disclosure and the inventions described herein is included in International Application No. PCT/US2009/002796 of Coe-Sullivan et al, filed 6 May 2009, entitled “Optical Components, Systems Including An Optical Component, And Devices”; International Application No. PCT/US2009/002789 of Coe-Sullivan et al, filed 6 May 2009, entitled “Solid State Lighting Devices Including Quantum Confined Semiconductor Nanoparticles, An Optical Component For A Solid State Light Device, And Methods”; International Application No. PCT/US2010/32859 of Modi et al, filed 28 Apr. 2010 entitled “Optical Materials, Optical Components, And Methods”; International Application No. PCT/US2010/032799 of Modi et al, filed 28 Apr. 2010 entitled “Optical Materials, Optical Components, Devices, And Methods”; International Application No. PCT/US2011/047284 of Sadasivan et al, filed 10 Aug. 2011 entitled “Quantum Dot Based Lighting”; International Application No. PCT/US2008/007901 of Linton et al, filed 25 Jun. 2008 entitled “Compositions And Methods Including Depositing Nanomaterial”; U.S. patent application Ser. No. 12/283,609 of Coe-Sullivan et al, filed 12 Sep. 2008 entitled “Compositions, Optical Component, System Including An Optical Component, Devices, And Other Products”; International Application No. PCT/US2008/10651 of Breen et al, filed 12 Sep. 2008 entitled “Functionalized Nanoparticles And Method”; U.S. Pat. No. 6,600,175 of Baretz, et al., issued Jul. 29, 2003, entitled “Solid State White Light Emitter And Display Using Same”; and U.S. Pat. No. 6,608,332 of Shimizu, et al., issued Aug. 19, 2003, entitled “Light Emitting Device and Display”; each of the foregoing being hereby incorporated herein by reference in its entirety.

LEDs within the scope of the present invention include any conventional LED such as those commercially available from Citizen, Nichia, Osram, Cree, or Lumileds. Useful light emitted from LEDs includes white light, off white light, blue light, green light and any other light emitted from an LED.

### Example I

### Preparation of Semiconductor Nanocrystals Capable of Emitting Red Light

Synthesis of CdSe Seed Cores: 262.5 mmol of cadmium acetate was dissolved in 3.826 mol of tri-n-octylphosphine at 100° C. in a 3 L 3-neck round-bottom flask and then dried and degassed for one hour. 4.655 mol of trioctylphosphine oxide and 599.16 mmol of octadecylphosphonic acid were added to a 5 L stainless steel reactor and dried and degassed at 140° C. for one hour. After degassing, the Cd solution was added to the reactor containing the oxide/acid and the mixture was heated to 310° C. under nitrogen. Once the temperature reached 310° C., the heating mantle is removed from the reactor and 731 mL of 1.5 M diisobutylphosphine selenide (DIBP-Se) (900.2 mmol Se) in 1-Dodecyl-2-pyrrolidinone (NDP) was then rapidly injected. The reactor is then immediately submerged in partially frozen (via liquid nitrogen) squalane bath rapidly reducing the temperature of the reaction to below 100° C. The first absorption peak of the nanocrystals was 480 nm. The CdSe cores were precipitated out of the growth solution inside a nitrogen atmosphere glovebox by adding a 3:1 mixture of methanol and isopropanol. After removal of the methanol/isopropanol mixture, the isolated cores were then dissolved in hexane and used to make core-shell materials. The isolated material specifications were as follows: Optical Density @ 350 nm=2.83; Abs=481 nm; Emission=510 nm; FWHM=40 nm; Total Volume=1.9 L of hexane.

Growth of CdSe cores: A 1 L glass reactor was charged with 320 mL of 1-octadecene (ODE) and degassed at 120° C. for 15 minutes under vacuum. The reactor was then backfilled with N2 and the temperature set to 60° C. 120 mL of the CdSe seed core above was injected into the reactor and the hexanes were removed under reduced pressure until the vacuum gauge reading was <500 mTorr. The temperature of the reaction mixture was then set to 240° C. Meanwhile, two 50 mL syringes were loaded with 80 mL of cadmium oleate in TOP (0.5 M conc.) solution and another two syringes were loaded with 80 mL of di-iso-butylphosphine selenide (DiBP-Se) in TOP (0.5 M conc.). Once the reaction mixture reached 240° C., the Cd oleate and DiBP-Se solutions were infused into the reactor at a rate of 35 mL/hr. The 1st excitonic absorption feature of the CdSe cores was monitored during infusion and the reaction was stopped at ˜60 minutes when the absorption feature was 569 nm. The resulting CdSe cores were then ready for use as is in this growth solution for overcoating.

Synthesis of CdSe/ZnS/CdZnS Core-Shell Nanocrystals: 115 mL of the CdSe core above with a first absorbance peak at 569 nm was mixed in a 1 L reaction vessel with 1-octadecene (45 mL), and Zn(Oleate) (0.5 M in TOP, 26 mL). The reaction vessel was heated to 120° C. and vacuum was applied for 15 min. The reaction vessel was then back-filled with nitrogen and heated to 310° C. The temperature was ramped, between 1° C./5 seconds and 1° C./15 seconds. Once the vessel reached 300° C., octanethiol (11.4 mL) was swiftly injected and a timer started. Once the timer reached 6 min., one syringe containing zinc oleate (0.5 M in TOP, 50 mL) and cadmium oleate (1 M in TOP, 41 mL), and another syringe containing octanethiol (42.2 mL) were swiftly injected. Once the timer reached 40 min., the heating mantle was dropped and the reaction cooled by subjecting the vessel to a cool air flow. The final material was precipitated via the addition of butanol and methanol (4:1 ratio), centrifuged at 3000 RCF for 5 min, and the pellet redispersed into hexanes. The sample is then precipitated once more via the addition of butanol and methanol (3:1 ratio), centrifuged, and dispersed into toluene for storage (616 nm emission, 25 nm FWHM, 80% QY, and 94% EQE in film).

### Example II

### Preparation of Semiconductor Nanocrystals Capable of Emitting Green Light

Synthesis of CdSe Cores: 262.5 mmol of cadmium acetate was dissolved in 3.826 mol of tri-n-octylphosphine at 100° C. in a 3 L 3-neck round-bottom flask and then dried and degassed for one hour. 4.655 mol of trioctylphosphine oxide and 599.16 mmol of octadecylphosphonic acid were added to a 5 L stainless steel reactor and dried and degassed at 140° C. for one hour. After degassing, the Cd solution was added to the reactor containing the oxide/acid and the mixture was heated to 310° C. under nitrogen. Once the temperature reached 310° C., the heating mantle was removed from the reactor and 731 mL of 1.5 M diisobutylphosphine selenide (DIBP-Se) (900.2 mmol Se) in 1-Dodecyl-2-pyrrolidinone (NDP) was then rapidly injected. The reactor was then immediately submerged in a partially frozen (via liquid nitrogen) squalane bath rapidly reducing the temperature of the reaction to below 100° C. The first absorption peak of the nanocrystals was 487 nm. The CdSe cores were precipitated out of the growth solution inside a nitrogen atmosphere glovebox by adding a 3:1 mixture of methanol and isopropanol. The isolated cores were then dissolved in hexane and used to make core-shell materials. The isolated material specifications were as follows: Optical Density @ 350 nm=1.62; Abs=486 nm; Emission=509 nm; FWHM=38 nm; Total Volume=1.82 L of hexane.

Synthesis of CdSe/ZnS/CdZnS Core-Shell Nanocrystals: 335 mL of 1-octadecene (ODE), 12.55 g of zinc acetate, and 38 mL of oleic acid were loaded into a 1 L glass reactor and degassed at 100° C. for 1 hour. In a 1 L 3-neck flask, 100 mL of ODE was degassed at 120° C. for 1 hour. After degassing, the temperature of the flask was reduced to 65° C. and then 23.08 mmol of CdSe cores from the procedure above (275 mL) were blended into the 100 mL of degassed ODE and the hexane was removed under reduced pressure. The temperature of the reactor was then raised to 310° C. In a glove box, the core/ODE solution and 40 mL of octanethiol were added to a 180 mL container. In a 600 mL container, 151 mL of 0.5 M Zn Oleate in TOP, 37 mL of 1.0 M Cd Oleate in TOP, and 97 mL of 2 M TOP-S were added. Once the temperature of the reactor hit 310° C., the ODE/QD cores/Octanethiol mixture was injected into the reactor and allowed to react for 30 min at 300° C. After this reaction period, the Zn Oleate/Cd Oleate/TOP-S mixture was injected to the reactor and the reaction was allowed to continue for an additional 30 minutes at which point the mixture was cooled to room temperature. The resulting core-shell material was precipitated out of the growth solution inside a nitrogen atmosphere glovebox by adding a 2:1 mixture of butanol and methanol. The isolated quantum dots (QDs) were then dissolved in toluene and precipitated a second time using 2:3 butanol:methanol. The QDs were finally dispersed in toluene. The isolated material specifications were as follows: Optical Density @ 450 nm (100 Fold Dilution)=0.32; Abs=501 nm; Emission=518 nm; FWHM=38 nm; Solution QY=60%; Film EQE=93%.

### Example III

### Preparation of Polymerizable Formulation Including Quantum Dots

A polymerizable formulation including quantum dots was prepared as follows:

A clean, dry Schlenk flask equipped with a magnetic stir bar and rubber septum was charged with 57.75 mL lauryl methacrylate (LMA) (Aldrich Chemical, 96%), 9.93 mL ethylene glycol diacrylate (EGDMA) as well as any additive(s) indicated for the particular example. The solution was inerted using a vacuum manifold and degassed in a standard protocol by freeze-pump-thawing the mixture three times successively using liquid nitrogen. The thawed solution is finally placed under nitrogen and labeled “monomer solution”.

Separately, a clean, dry Schlenk flask equipped with a magnetic stir bar and rubber septum was charged with 6.884 g treated fumed silica (TS-720, Cabot Corp), 103.1 mg titanium dioxide (R902+, DuPont Corp.) and inerted under nitrogen. To this is added 69 mL toluene (dry and oxygen free). The mixture is placed in an ultrasonic bath for 10 minutes and then stirred under nitrogen. This is labeled “metal oxide slurry”.

Separately, a clean, dry Schlenk flask equipped with a magnetic stir bar and rubber septum was inerted under nitrogen. The flask was then charged with a green quantum dot solution (13.1 mL of quantum dots prepared as generally described in Example II above) in toluene, red quantum dot solution (2.55 mL of quantum dots prepared as generally described in Example I above) in toluene and 69 mL additional toluene via syringe and allowed to stir for 5 minutes. Over 6 minutes, the contents of the “monomer solution flask” were added via syringe and stirred for an additional five minutes. The contents of the “metal oxide slurry” flask were next added over 5 minutes via cannula and rinsed over with the aid of a minimum amount of additional toluene.

The stirred flask was then placed in a warm water bath (<60° C.), covered with aluminum foil to protect from light and placed under a vacuum to remove all of the toluene to a system pressure of <200 mtorr. After solvent removal was completed, slurry was removed from heat and, with stirring, 640 μL Irgacure 2022 photoinitiator (BASF), without purification, was added via syringe and allowed to stir for 5 minutes. The final ink was then ready for transfer to a fill station.

### Example IV

### Filling Capillary, Forming Quantum Dot Matrix, and Capillary Sealing

According to aspects of the present disclosure, tubes can be filled individually in series one at a time or they can be filled in parallel with many tubes being filled at the same time, such as in a batch method. Methods of filling tubes can use capillary action, pressure differentials, gravity, vacuum or other forces or methods known to those of skill in the art to fill tubes with flowable quantum dot formulations. According to one aspect, a stress-resistant tube was filled under oxygen free conditions with the quantum dot formulation of Example III as follows. Glass capillaries are maintained in a vacuum drying oven under nitrogen for 12 hours at a pressure of less than 1 torr and a temperature of 120° C. A quantum dot ink formulation of Example III is maintained in a quantum dot ink vessel under nitrogen. Capillaries with both ends open are removed from the vacuum drying oven and placed into a vacuum fill vessel with an open end down into quantum dot ink. The quantum dot ink vessel is connected to the vacuum fill vessel via tubing and valves such that ink is able to flow from the quantum dot ink vessel to the vacuum fill vessel by applying pressure differentials. The pressure within the vacuum fill vessel is reduced to less than 200 torr and then repressurized with nitrogen. Quantum dot ink is admitted into the vacuum fill vessel by pressurization of the quantum dot ink vessel and the capillaries were allowed to fill under oxygen free conditions. Alternatively, the vacuum fill vessel can be evacuated thereby drawing the fluid up into the capillaries. After the capillaries are filled, the system is bled to atmospheric pressure. The exterior of the capillaries is then cleaned using toluene. The polymerizable formulation within the glass tube is polymerized as follows. The tubes are transferred to a photopolymerization reactor where the tubes are placed on a continuously moving belt and exposed for 30 seconds to light from a mercury “H” or “D” lamp at a fluence of 250-1000 J/cm. After polymerization, the tubes are end sealed, preferably under a nitrogen atmosphere, using an epoxy.

According to an additional embodiment with reference to FIG. 2, a capillary with one end sealed is connected to a filling head. A suitable filling head holds and maintains the capillary in a vacuum tight seal. The capillary is evacuated by vacuum. Quantum dot ink under nitrogen pressure is then filled into the capillary. The quantum dot ink is maintained at a temperature below which thermal-induced polymerization takes place. Alternatively, a pump can be used to pump the quantum dot ink through a filling head and into the capillary. The quantum dot ink can be maintained under vacuum sufficient to degas the quantum dot ink. The ink may be agitated or stirred or recirculated which aids in the degassing process. If a recirculation loop is used, heat may be generated by the pump used to recirculate the quantum dot ink which may increase the temperature of the quantum dot ink. To maintain the temperature of the quantum dot ink at a temperature below which thermal-induced polymerization takes place, a heat exchanger may be used within the recirculating loop to remove heat from the quantum dot ink that may have been added due to the recirculating pump. The lines and filling head is flushed with nitrogen. The capillary is then removed from the filling head under an atmosphere of nitrogen or nitrogen is backfilled into the capillary and the end sealed, such as by melting the capillary end and sealing, to produce an optical component comprising a structural member (e.g., a vessel, a capillary, a tube, etc.) including a quantum dot formulation therein and having no or substantially no oxygen within the sealed optical component. The quantum dot ink in the sealed capillary is then cured within, the capillary through exposure to ultra violet light of 395 nm wavelength or equivalent wavelength.

The completed, sealed capillary(ies) were exposed to 30 mW/cm2 light flux with a wavelength of about 450 nm, for 12 hours at 60° C. prior to any analytical testing.

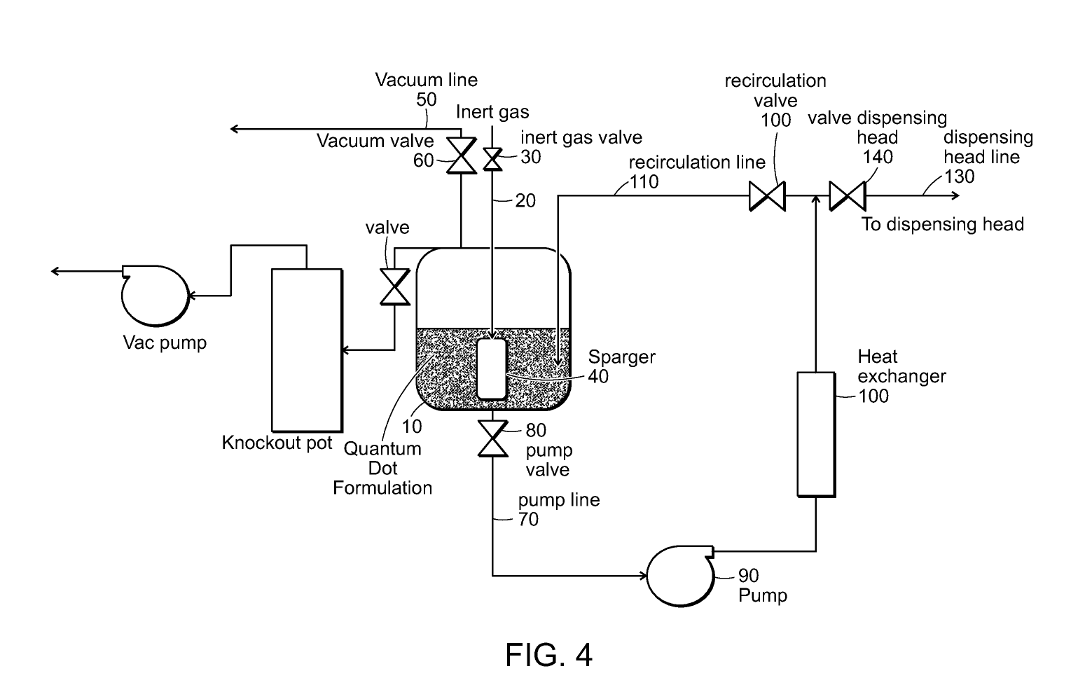

An exemplary system for maintaining and processing a quantum dot formulation is shown in schematic in FIG. 4. A quantum dot formulation is maintained in a closed vessel 10. The vessel includes an inert gas input line 20 for inputting inert gas into the vessel 10 through an inert gas valve 30. The inert gas input line is connected to a sparger 40 disposed within the vessel 10 and is intended to be covered with the quantum dot formulation as shown. Inert gas moves through the inert gas input line 20 into the vessel 10 and into the quantum dot formulation. A vacuum line 50 is connected to the vessel 10 through vacuum valve 60. The vacuum line 50 is connected to a vacuum (not shown). The vacuum draws a vacuum within the closed vessel 10 thereby removing any inert gas and any gases such as oxygen that may be dissolved within the quantum dot formulation. The vessel may also include a stirrer (not shown) which can stir the quantum dot formulation within the vessel. The inert gas valve may be closed thereby subjecting the quantum dot formulation within the vessel 10 to a vacuum which serves to degas the quantum dot formulation. A pump line 70 is connected to the vessel 10 through pump valve 80. A pump 90 is used to pump quantum dot formulation out of the vessel 10. The quantum dot formulation can enter heat exchanger 100 which serves to maintain the quantum dot formulation at a desired temperature. The quantum dot formulation may then enter a recirculation line 110 via a recirculation valve 120. The recirculation line 110 returns the quantum dot formulation to the vessel 10. The quantum dot formulation may enter a dispensing head line 130 via a dispensing head valve 140.

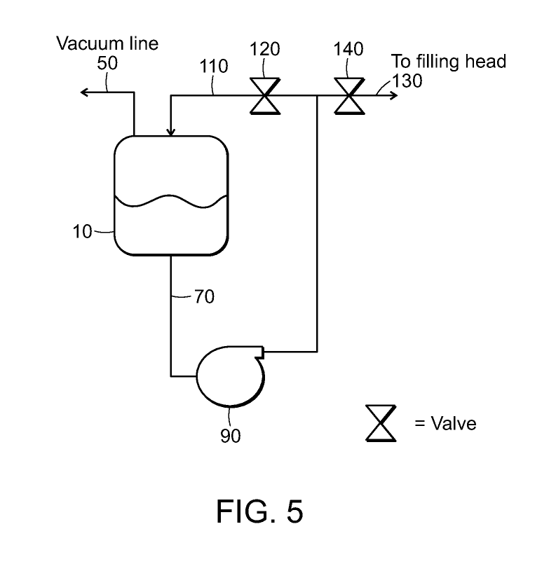

According to an alternative embodiment shown in schematic in FIG. 5, a closed vessel 10 includes a quantum dot formulation. A vacuum line 50 is attached to the vessel 10 through a vacuum valve. A vacuum (not shown) is attached to the vacuum line and draws a vacuum within the closed vessel 10. A pump line 70 is connected to the vessel 10 through pump valve. A pump 90 is used to pump quantum dot formulation out of the vessel 10. The quantum dot formulation may then enter a recirculation line 110 via a recirculation valve 120. The recirculation line 110 returns the quantum dot formulation to the vessel 10. The quantum dot formulation may enter a dispensing head line 130 via a dispensing head valve 140.

According to an alternate embodiment shown in schematic in FIG. 6, a closed vessel 10 includes a quantum dot formulation. A vacuum line 50 is attached to the vessel 10 through a vacuum valve. A vacuum (not shown) is attached to the vacuum line and draws a vacuum within the closed vessel 10. An inert gas input line 20 for inputting inert gas into the vessel 10 is connected to the vessel 10 through an inert gas valve. A stirrer 15 is placed within the vessel 10 for stirring the quantum dot formulation. The quantum dot formulation may enter a dispensing head line 130 via a dispensing head valve 140. According to this embodiment, pressure from the inert gas is used to force quantum dot formulation from the vessel 10 through the dispensing head line and to the dispensing or filling head.

According to an alternate embodiment shown in schematic in FIG. 7, a vessel 10 includes a quantum dot formulation. A stirrer 15 is disposed within the vessel 10 for stirring the quantum dot formulation. The vessel 10 may be open or closed and may be subject to ambient atmosphere. An exit line 150 is connected to the vessel 10 through which the quantum dot formulation may flow. A closed degassing chamber 160 is connected to the exit line 150. The degassing chamber is preferably smaller than the vessel 10 and is designed to degas small volumes of the quantum dot formulation. A vacuum line 50 is attached to the degassing chamber 160 through a vacuum valve. A vacuum (not shown) is attached to the vacuum line and draws a vacuum within the closed degassing chamber 160. The quantum dot formulation within the degassing chamber may enter a dispensing head line 130 via a dispensing head valve.

As used herein, the singular forms “a”, “an” and “the” include plural unless the context clearly dictates otherwise. Thus, for example, reference to an emissive material includes reference to one or more of such materials.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of making a quantum dot-containing vessel comprising
maintaining the vessel under oxygen-free conditions,
maintaining a quantum dot formulation under oxygen-free conditions,
introducing the quantum dot formulation into the vessel under oxygen-free conditions, wherein the quantum dot formulation is degassed under oxygen free conditions prior to being introduced into the vessel, and
sealing the vessel wherein the quantum dot formulation within the vessel is under oxygen-free conditions.

2. The method of claim 1 wherein the vessel includes a sealed end before introduction of the quantum dot formulation.

3. The method of claim 1 wherein the vessel is placed under vacuum before introduction of the quantum dot formulation.

4-7. (canceled)

8. The method of claim 1, further comprising placing a vessel under vacuum, filling the vessel with a predetermined amount of the quantum dot formulation in the substantial absence of oxygen and sealing the vessel after introduction of the quantum dot formulation.

9. The method of claim 1 wherein the quantum dot formulation is under nitrogen when introduced into the vessel.

10. The method of claim 1 wherein the quantum dot formulation is under an inert atmosphere when introduced into the vessel.

11. The method of claim 1 wherein the quantum dot formulation is under vacuum when introduced into the vessel.

12. The method of claim 1 wherein the vessel is sealed under oxygen-free conditions after introduction of the quantum dot formulation.

13. The method of claim 1 wherein the vessel is a container.

14. The method of claim 1 wherein the vessel is a tube.

15. The method of claim 1 wherein the vessel is a capillary.

16. The method of claim 1 wherein the vessel is a glass tube defined by a light transmissive wall including a first full radius end and a second full radius end and with substantially parallel walls connecting the first full radius end and the second full radius end with the substantially parallel walls defining a uniform path length.

17. The method of claim 1 wherein the vessel is hermetically sealed and wherein oxygen is absent or substantially absent therein.

18. A method for making an optical component comprising
introducing a polymerizable formulation including quantum dots into a vessel defined by a light transmissive structure under oxygen-free conditions and thereafter hermetically sealing the vessel.

19. The method of claim 18 further comprising polymerizing the polymerizable formulation to form a matrix including quantum dots.

20. A quantum dot-containing vessel comprising
a tube having a quantum dot formulation therein under oxygen-free conditions.

21-22. (canceled)

23. The quantum dot-containing vessel of claim 20 being hermetically sealed.

24-25. (canceled)

26. The quantum dot containing vessel of claim 20 being a glass tube defined by a light transmissive wall including a first full radius end and a second full radius end and with substantially parallel walls connecting the first full radius end and the second full radius end with the substantially parallel walls defining a uniform path length.

27-32. (canceled)

33. The method of claim 18 wherein the quantum dot formulation is degassed under oxygen free conditions prior to being introduced into the vessel.

34. The quantum dot containing vessel of claim 20 wherein the quantum dot formulation contains no dissolved or entrapped gas.

35. (canceled)
